(19) United States
(12) Patent Application Publication
(10) Pub. No.: US 2007/0223742 A1
(43) Pub. Date: Sep. 27, 2007

(54) AUDIO CONTROL SYSTEM WITH HOT PLUG-AND-PLAY MECHANISM AND METHOD THEREOF

(75) Inventors: Jo-Chieh Ma, Taipei (TW); Ta-Jung Yeh, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA TECHNOLOGIES, INC., Taipei (TW)

(21) Appl. No.: 11/682,919

(22) Filed: Mar. 7, 2007

(30) Foreign Application Priority Data
Mar. 7, 2006 (TW) 95107633

(51) Int. Cl. H02B 1/00

(52) U.S. Cl. 381/123

(57) ABSTRACT

An audio control system with a hot plug-and-play mechanism and a method thereof, which can effectively solve the defects that devices of a conventional high definition audio specification must be fixed on a mother board and cannot be hot plugged and played so that the convenience and the time efficiency in use can be enhanced. The audio control system includes an audio controller, a first audio encoder/decoder and a second audio encoder/decoder. The audio controller has a first reset signal and a second reset signal. The first audio encoder/decoder is coupled to the audio controller and receives the first reset signal. The second audio encoder/decoder is coupled to the audio controller and receives the second reset signal. The hot plug-and-play mechanism can be achieved when the audio controller selectively enables the first reset signal or the second reset signal.

This application claims the benefit of Taiwan application Serial No. 95107633, filed Mar. 7, 2006, the subject matter of which is incorporated herein by reference.

### BACKGROUND OF THE INVENTION

1. Field of the Invention

The invention relates in general to an audio control system with a hot plug-and-play mechanism and a method thereof, and more particularly to an audio control system having a high definition audio specification and a hot plug-and-play mechanism, and a method thereof.

2. Description of the Related Art

With the popularization of the computer, the demands on the multimedia computers are getting higher and higher. So, most computers are equipped with audio devices for voice output and input. However, the operations inside the computer are conducted according to digital signals, and the voice pertains to the analog signal. Thus, the audio device for the voice output and input must have the ability of converting the digital signal into the analog voice signal, and converting the analog voice signal into the digital signal acceptable by the computer, and the ability pertains to the conventional audio encoder/decoder (CODEC). On the other hand, the audio encoder/decoder is also controlled by the audio controller in response to the application of the many audio encoder/decoders in the computer system.

The main feature of the present technology, such as the AC'97 audio system standard disclosed by Intel, is that the analog circuit of the audio system is integrated on a single chip such that the signal to noise ratio of the audio in the computer is increased to prevent the analog signal from being interfered with the digital signal of the computer system and the audio quality can be enhanced.

FIG. 1 (Prior Art) is a block diagram showing a conventional audio control system having the high definition audio specification proposed by Intel. The audio control system with the high definition audio specification is not compatible with the AC'97 audio system, and the link protocol and the operation method of the audio control system are different from those of the AC'97 audio system. The AC'97 audio system under the mode of 48 KHz/20 bit can support at most six channels, while the high definition audio specification under the mode of 192 KHz/32 bit can support at most eight channels and have the better audio quality. The details about the high definition audio specification can be obtained from the website of Intel, so detailed descriptions thereof will be omitted.

Referring to FIG. 1, an audio control system 100 includes an audio controller 10, an audio encoder/decoder 12, an audio encoder/decoder 14 and an audio encoder/decoder 16. The audio controller 10 controls the audio encoder/decoder 12, the audio encoder/decoder 14 and the audio encoder/decoder 16 through a reset signal RST, a series data output signal SDOUT, a sync signal SYNC and a clock signal CLK. The audio controller 10 and the audio encoder/decoder 12 further communicate with each other via signals through a series data input signal SDI0. Similarly, the audio controller 10 and the audio encoder/decoder 14 communicate with each other via signals through a series data input signal SDI1, and the audio controller 10 and the audio encoder/decoder 16 communicate with each other via signals through a series data input signal SDI2.

The audio controller 10 simultaneously resets the audio encoder/decoder 12, the audio encoder/decoder 14 and the audio encoder/decoder 16 through the reset signal RST when the power is on, and then sequentially performs a frame connecting procedure, a frame turnaround procedure and a frame addressing procedure such that the audio controller 10 can correctly distinguish between and control the audio encoder/decoder 12, the audio encoder/decoder 14 and the audio encoder/decoder 16.

It is to be noted that because the reset signals RST for resetting the audio encoder/decoder 12, the audio encoder/decoder 14 and the audio encoder/decoder 16 come from the same circuit, all audio encoder/decoders will be reset as long as any one of the audio encoder/decoders has to be reset. Once all the audio encoder/decoders are reset due to the reset of any one of the audio encoder/decoders, the user cannot directly hot plug-and-play the product. In the case that most computer peripheral apparatuses support the hot plug-and-play function, it is quite inconvenient in use according to the habit, and each reset operation also deteriorates the time efficiency in use.

Furthermore, because the reset signals come from the same circuit, the audio controller 10, the audio encoder/decoder 12, the audio encoder/decoder 14 and the audio encoder/decoder 16 have to be fixed on a circuit board or a mother board and cannot be individually removed and then plugged and played again.

So, it is an important object of the invention to eliminate the drawback that the conventional audio control system with the high definition audio specification cannot be hot plugged and played and must be fixed on the mother board, and to enhance the convenience and the time efficiency in use.

### SUMMARY OF THE INVENTION

The invention is directed to an audio control system with a hot plug-and-play mechanism and a method thereof in order to overcome the drawbacks that the conventional audio control system with a high definition audio specification has to be fixed on one mother board and cannot be hot plugged and played effectively so that the convenience and time efficiency in use may be enhanced.

According to a first aspect of the present invention, an audio control system with a hot plug-and-play mechanism is provided. The audio control system comprises an audio controller, a first audio encoder/decoder and a second audio encoder/decoder. The audio controller has a first reset signal and a second reset signal. The first audio encoder/decoder is coupled to the audio controller and receives the first reset signal. The second audio encoder/decoder is coupled to the audio controller and receives the second reset signal. The audio controller can selectively assert the first reset signal or the second reset signal.

According to a second aspect of the present invention, an audio control method with a hot plug-and-play mechanism is provided. The audio control method includes the steps of: selectively enabling a first reset signal and a second reset signal coming from an audio controller; and determining whether to reset a first audio encoder/decoder according to the first reset signal, and whether to reset a second audio encoder/decoder according to the second reset signal.

The invention will become apparent from the following detailed description of the preferred but non-limiting embodiments. The following description is made with reference to the accompanying drawings.

### BRIEF DESCRIPTION OF THE DRAWINGS

FIG. 1 (PriorArt) is a block diagram showing a conventional audio control system.

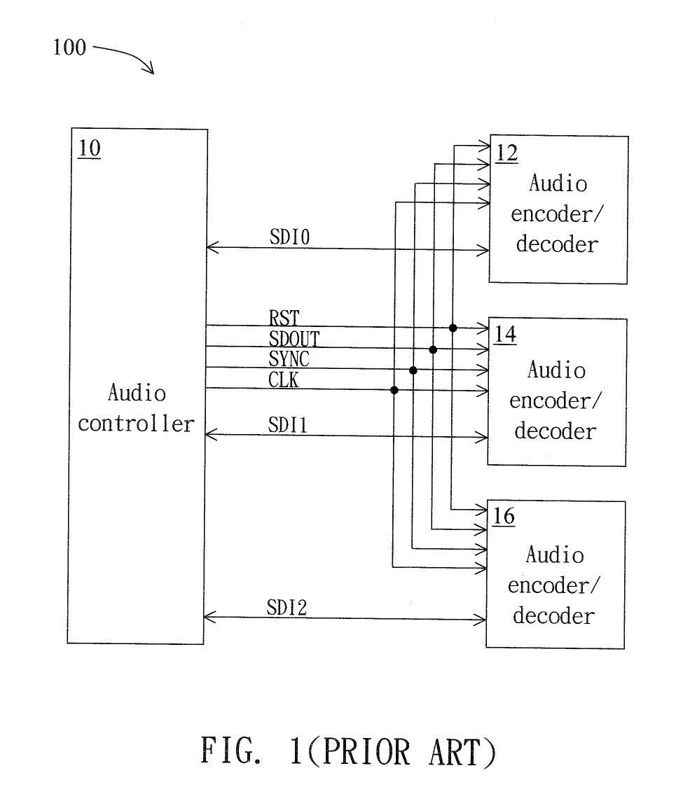

FIG. 2 is a block diagram showing an audio control system of the invention.

FIG. 3 is a flow chart showing an audio control method of the invention.

### DETAILED DESCRIPTION OF THE INVENTION

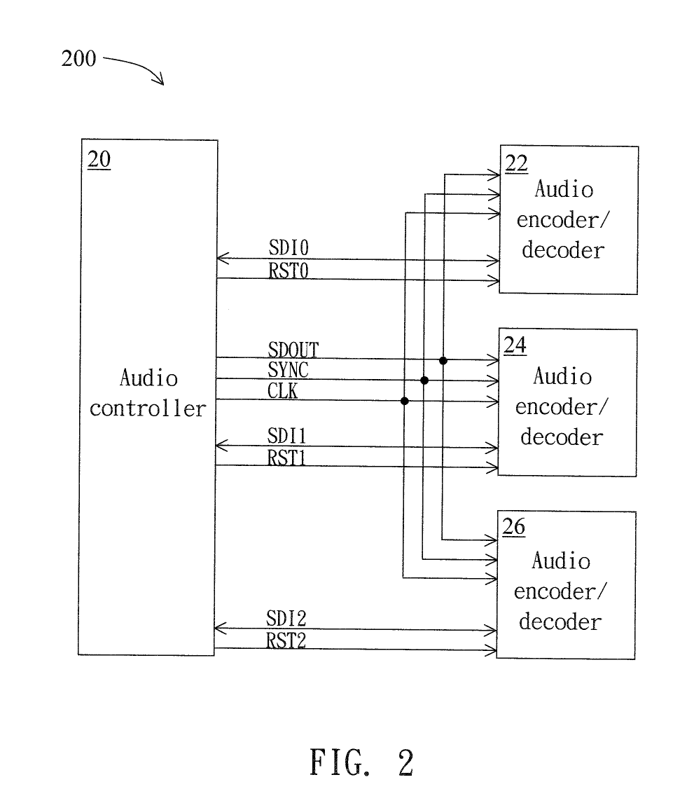

FIG. 2 is a block diagram showing an audio control system 200 of the invention. Referring to FIG. 2, the audio control system 200 includes an audio controller 20, an audio encoder/decoder (Audio CODEC) 22, an audio encoder/decoder 24 and an audio encoder/decoder 26. The audio controller 20 controls the audio encoder/decoder 22, the audio encoder/decoder 24 and the audio encoder/decoder 26 according to a series data output signal SDOUT, a sync signal SYNC (e.g., a working frequency thereof is 48 KHz, depending upon a supporting condition of the audio encoder/decoder), and a clock signal CLK (e.g., a highest working frequency thereof is 24 MHz). In addition, the audio controller 20 further controls the audio encoder/decoder 22, the audio encoder/decoder 24 and the audio encoder/decoder 26 according to a reset signal RST0, a reset signal RST1, a reset signal RST2, respectively. The series data output signal SDOUT is for transmitting data, the sync signal SYNC is for controlling the data and the command synchronously, and the clock signal CLK serves as a reference for system operations. The audio controller 20 and the audio encoder/decoder 22 further communicate with each other via signals through a series data input signal SDI0. Similarly, the audio controller 20 and the audio encoder/decoder 24 communicate with each other via signals through a series data input signal SDI1, and the audio controller 20 and the audio encoder/decoder 26 communicate with each other via signals through a series data input signal SDI2.

The audio controller 20 may respectively control the corresponding audio encoder/decoder 22, the corresponding audio encoder/decoder 24 and the corresponding audio encoder/decoder 26 through individual transmitting circuits (not shown) according to the reset signal RST0, the reset signal RST1 and the reset signal RST2. Because different reset signals are coupled to different audio encoder/decoders, each of the reset signal RST0, the reset signal RST1 and the reset signal RST2 may be selected to be asserted or de-asserted when the power is on or the system is warm-booted so that the audio encoder/decoder 22, the audio encoder/decoder 24 and the audio encoder/decoder 26 may be reset. Then, the reset signal RST0, the reset signal RST1 and the reset signal RST2 are de-asserted so that the subsequent procedure can be performed.

When the single audio encoder/decoder has to be reset, for example, when only the audio encoder/decoder 24 has to be reset, the audio encoder/decoder 24 can be individually reset according to the reset signal RST1 while the audio encoder/decoder 22 and the audio encoder/decoder 26 are not reset. Then, all of the reset signal RST0, the reset signal RST1 and the reset signal RST2 are de-asserted so that the subsequent procedure can be performed.

Consequently, the audio controller 20 may selectively assert the reset signal RST0, the reset signal RST1, the reset signal RST2 so as to determine which one of the audio encoder/decoders has to be asserted.

In other words, when any peripheral apparatus is removed and then plugged again, the audio controller 20 can individually reset the audio encoder/decoder, such as the audio encoder/decoder 24, corresponding to the plugged peripheral apparatus without influencing other audio encoder/decoders.

After the reset signal RST0, the reset signal RST1 and the reset signal RST2 are de-asserted, the audio controller 20 performs a frame connecting procedure and a frame turnaround procedure for the audio encoder/decoder 22, the audio encoder/decoder 24 and the audio encoder/decoder 26 so as to initialize the audio encoder/decoder 22, the audio encoder/decoder 24 and the audio encoder/decoder 26. Then, a frame addressing procedure is performed to address the audio encoder/decoder 22, the audio encoder/decoder 24 and the audio encoder/decoder 26. The addressed audio encoder/decoder 22, the addressed audio encoder/decoder 24 and the addressed audio encoder/decoder 26 can be controlled by the audio controller 20. If the audio encoder/decoder 22, the audio encoder/decoder 24 or the audio encoder/decoder 26 has been addressed, the frame addressing procedure does not work.

In brief, the audio control system of the invention asserts the user to directly hot plug-and-play the peripheral apparatus without changing the present habit in use so that the convenience and time efficiency in use may be enhanced.

Furthermore, because the audio control system of the invention can be hot plugged and played, the flexibility of the circuit design can be enhanced, and the audio encoder/decoder can be disposed within any peripheral apparatus so that the audio encoder/decoder can be used after being connected to the audio controller when needed. Thus, the product can be widely used.

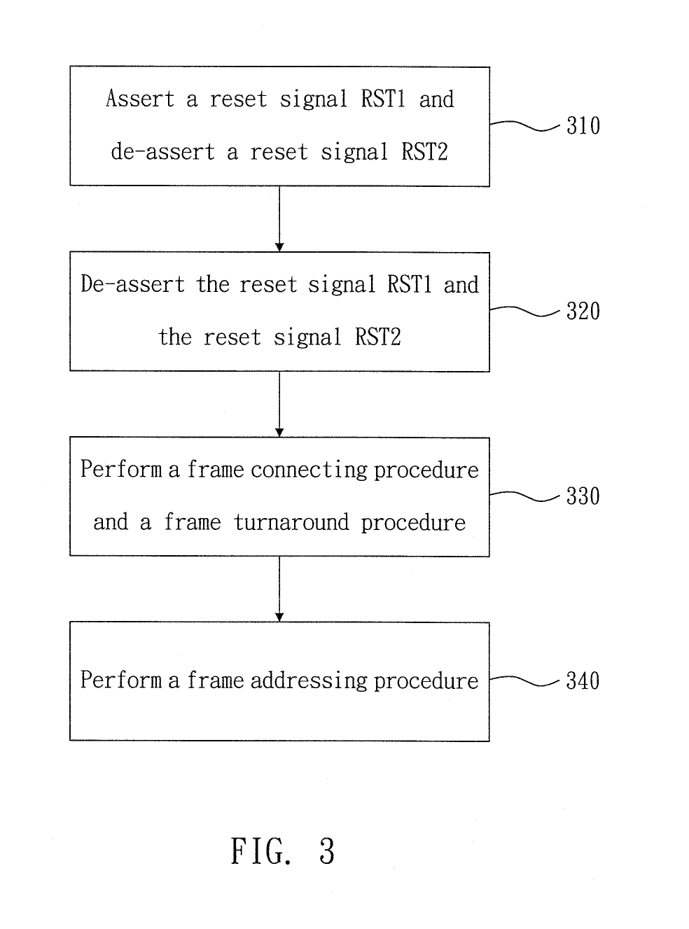

FIG. 3 is a flow chart showing an audio control method of the invention, which is adapted to the audio control system of FIG. 2. For the sake of simplicity, the operations of the signals associated with the audio encoder/decoder 22 will be omitted.

In step 310, when only the audio encoder/decoder 24 has to be reset, the reset signal RST1 is asserted and the reset signal RST2 is de-asserted such that only the audio encoder/decoder 24 receives the asserted reset signal RST1 and the audio encoder/decoder 26 receives the de-asserted reset signal RST2.

In step 320, the reset signal RST1 and the reset signal RST2 are de-asserted. Then, step 330 performs the frame connecting procedure and the frame turnaround procedure to initialize the audio encoder/decoder 24.

Next, step 340 performs the frame addressing procedure to address the audio encoder/decoder 24. The addressed audio encoder/decoder 24 can be controlled by the audio controller 20.

It is to be noted that the audio control system of the invention can be applied to a computer (e.g., a personal computer, a notebook computer, a tablet computer or the like), a handheld apparatus (e.g., a mobile phone, a music player, a digital camcorder or the like) with an audio playing function, a home apparatus (e.g., a television, a video phone or the like), and other apparatuses. In addition, the audio control system and the method of the invention still satisfy the requirement of the high definition audio specification.

The audio control system and the method of the invention can effectively eliminate the drawbacks that the audio control system with the high definition audio specification cannot be hot plugged and played and has to be fixed on the mother board so that the convenience and time efficiency in use may be enhanced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An audio control system with a hot plug-and-play mechanism, the audio control system comprising:
an audio controller for providing a first reset signal and a second reset signal;
a first audio encoder/decoder, which is coupled to the audio controller and receives the first reset signal; and
a second audio encoder/decoder, which is coupled to the audio controller and receives the second reset signal, wherein
the audio controller can selectively assert the first reset signal or the second reset signal for resetting the first audio encoder/decoder or the second audio encoder/decoder respectively.

2. The system according to claim 1, further comprising at least one transmitting circuit for transmitting the first reset signal or the second reset signal.

3. The system according to claim 1, wherein the audio controller asserts the first reset signal and de-asserts the second reset signal.

4. The system according to claim 1, wherein the audio controller de-asserts the first reset signal and the second reset signal.

5. The system according to claim 1, wherein the audio controller asserts the first reset signal and the second reset signal.

6. The system according to claim 1, wherein the audio controller communicates with the first audio encoder/decoder through a first series data input signal, and the audio controller communicates with the second audio encoder/decoder through a second series data input signal.

7. The system according to claim 1, wherein the audio control system satisfies a high definition audio specification.

8. An audio control method with a hot plug-and-play mechanism, the method comprising the steps of:
providing a first reset signal and a second reset signal by an audio controller;
resetting a first audio encoder/decoder when the first reset signal being asserted; and
resetting a second audio encoder/decoder when the second reset signal being asserted.

9. The method according to claim 8, wherein the first reset signal and the second reset signal being asserted simultaneously.

10. The method according to claim 8, wherein the first reset signal and the second reset signal being de-asserted simultaneously.

11. The method according to claim 8, wherein the first reset signal being asserted but the second reset signal being de-asserted.

12. The method according to claim 8, wherein the first reset signal being de-asserted but the second reset signal being asserted.

13. The method according to claim 8, further comprising the steps of:
providing a first series data input signal for communicating the audio controller and the first audio encoder/decoder; and
providing a second series data input signal for communicating the audio controller and the second audio encoder/decoder.

14. The method according to claim 13, further comprising the step of:
performing a frame connecting procedure and a frame turnaround procedure to initialize the first audio encoder/decoder and the second audio encoder/decoder.

15. The method according to claim 14, further comprising the step of:
performing a frame addressing procedure to address the first audio encoder/decoder and the second audio encoder/decoder.

16. The method according to claim 15, wherein the audio control method satisfies a high definition audio specification.

17. An audio control method with a hot plug-and-play mechanism, the method being adapted to an audio control system having an audio controller, a first audio encoder/decoder and a second audio encoder/decoder, wherein the audio controller is coupled to the first audio encoder/decoder and the second audio encoder/decoder through at least two transmitting circuits, the audio control method comprising the steps of:
providing a first reset signal and a second reset signal;
selectively asserting the first reset signal or the second reset signal; and
transmitting the enabled first reset signal or the enabled second reset signal to the first audio encoder/decoder or the second audio encoder/decoder through a corresponding transmitting circuit to reset the first audio encoder/decoder or the second audio encoder/decoder.

18. The method according to claim 17, further comprising, after resetting the first audio encoder/decoder or the second audio encoder/decoder, the step of:
de-asserting the first reset signal and second reset signal.

19. The method according to claim 17, wherein the audio controller further provides a first series data input signal and a second series data input signal for communication with the first audio encoder/decoder and the second audio encoder/decoder, respectively.

20. The method according to claim 19, further comprising the step of:
performing a frame connecting procedure and a frame turnaround procedure to initialize the first audio encoder/decoder and the second audio encoder/decoder.

21. The method according to claim 20, further comprising the step of:
performing a frame addressing procedure to address the first audio encoder/decoder and the second audio encoder/decoder.
